(19) United States
(12) Patent Application Publication
(10) Pub. No.: US 2006/0015466 A1
(43) Pub. Date: Jan. 19, 2006

(54) Method and apparatus for controlling and metering usage of software products with an optimized license use

(76) Inventors: Mario Noioso, Roma (IT); Domenico Di Giulio, Roma (IT); Riccardo Rossi, Roma (IT); Manuela Bassani, Roma (IT)

Correspondence Address: IBM CORPORATION;INTELLECTUAL PROPERTY LAW, 11400 BURNET ROAD, AUSTIN, TX, 78758, US

(21) Appl. No.: 11/181,404

(22) Filed: Jul. 14, 2005

(30) Foreign Application Priority Data
Jul. 15, 2004 (FR) 04368049.5

(51) Int. Cl. G06F 17/60

(52) U.S. Cl. 705/59

(57) ABSTRACT

A method and a corresponding apparatus for controlling and metering usage of software products on a computer are proposed. In a license manager software product, when several licenses are available for the same product a method for determining the best license is proposed in order to maximize the exploitation of the licenses. The solution of the invention is based on the idea that, if a choice is possible, it is preferable to use a license with a narrower scope, leaving a license with a wider applicability for future needs. According to the present invention the licenses are stored on a catalogue with an associated list of attributes indicative of usage constraints of the product. The licenses are ordered according to predetermined attributes optimization criteria, so that when a request is received, the license manager can easily find the best license, i.e. that license, suitable for the requested use, having the highest usage constraint, saving the more flexible licenses for future needs.

### TECHNICAL FIELD

The present invention relates to the data processing field. More specifically, the present invention relates to a method of controlling and metering usage of software products on a data processing system. The invention further relates to a computer program for performing the method, and to a product embodying the program. Moreover, the invention also relates to a corresponding apparatus.

### BACKGROUND ART

Software products (such as computer programs) can be perfectly reproduced in an infinite number of copies. This is a major concern for publishers of the products wishing to protect their intellectual property rights; indeed, the publishers typically receive a royalty for a licensed use of each product, so that any unaccounted use or distribution of the product results in unpaid royalties. The problem has been exacerbated in the last years by the widespread diffusion of the Internet, which further facilitates the uncontrolled distribution of this kind of products.

The most straightforward way of avoiding unaccounted usage of the products is that of preventing unauthorized copying and transmission. For example, some products embed control code that limits the number of copies that can be made or disables operation of the products after a predetermined period of time has lapsed. Another technique consists of requiring possession of a software or hardware key for running the products. A different solution consists of modifying each product to include a call to a licensing management system. Every time the product is started, a corresponding request is transferred to the licensing management system. The licensing management system verifies whether the usage of the product is authorized. If the result of the verification is positive, the product can continue its execution; otherwise, the product is forced to stop.

However, the technique described above requires each product to be modified by the publisher, so that they are not of general applicability. In addition, the solutions known in the art are quite rigid and cannot be readily adapted to different requirements.

A different approach is based on the use of a software catalogue. The software catalogue lists all the known products to be metered; each product is identified by one or more executable modules indicative of its running. In this case, a licensing agent working in the background detects the executable modules that have been launched; the licensing agent then identifies the corresponding products through the software catalogue.

For this purpose, the licensing agent periodically collects a list of the executable modules that are currently running. For each executable module, if the corresponding product is not authorized the licensing agent may kill the respective process (so as to stop execution of the product), and may make the product unable to start again. Alternatively, as described in WO-A-03038570, the licensing agent detects any new process that is started in response to the request of execution of a product (for example, using a kernel hooking technique). The process is suspended and an authorization to run the product is verified. If the authorization is granted, the process is resumed so as to enable the product to start. Conversely, the process is aborted thereby preventing execution of the product; this avoids killing the product while it is performing potentially risky operations.

It could happen with the techniques based on the software catalogue that several licenses might be available on the catalogue for the same product. When a request is received by the SERVER and different versions of the same product are available and suitable for that request, the SERVER should have an efficient mechanism to choose which of the several licenses is to be granted. Typically, commercially available License Manager products just make sure that a valid license exists for each request received, without trying to determine the best license among the plurality of available licenses. Such an optimization mechanism would be very helpful for maximizing the exploitation of the available licenses in term of use and consumption. It is an object of the present invention to provide a method and a system which alleviates the above drawbacks.

### SUMMARY OF THE INVENTION

According to the present invention we provide a method of metering usage of at least one software product on a data processing system, the at least one software product having a plurality of available associated licenses, each license having a set of attributes, the method including the steps of: determining for each attribute a preference rule; detecting an event indicative of the use of the at least one product on the system; and responsive to the detection, identifying the best available license for the product among said plurality of licenses, according to said preference rules.

In this way, when several licenses are available and suitable for the current needs, the more general ones (i.e. with a broader scope) are kept for future requests, in order to maximise the use of the licenses.

A further aspect of the present invention provides a computer program for performing the above-described method.

A still further aspect of the invention provides a program product embodying this program. Moreover, another aspect of the invention provides a corresponding apparatus for metering usage of software products.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

FIG. 1a is a schematic block diagram of a data processing system in which the method of the invention is applicable;

FIG. 1b shows the functional blocks of a generic computer of the system;

FIG. 2 depicts the main software components that can be used for practicing the method; and

FIG. 3 show a diagram describing the flow of activities relating to an illustrative implementation of the method.

### DETAILED DESCRIPTION OF THE PREFERRED EMBODIMENT(S)

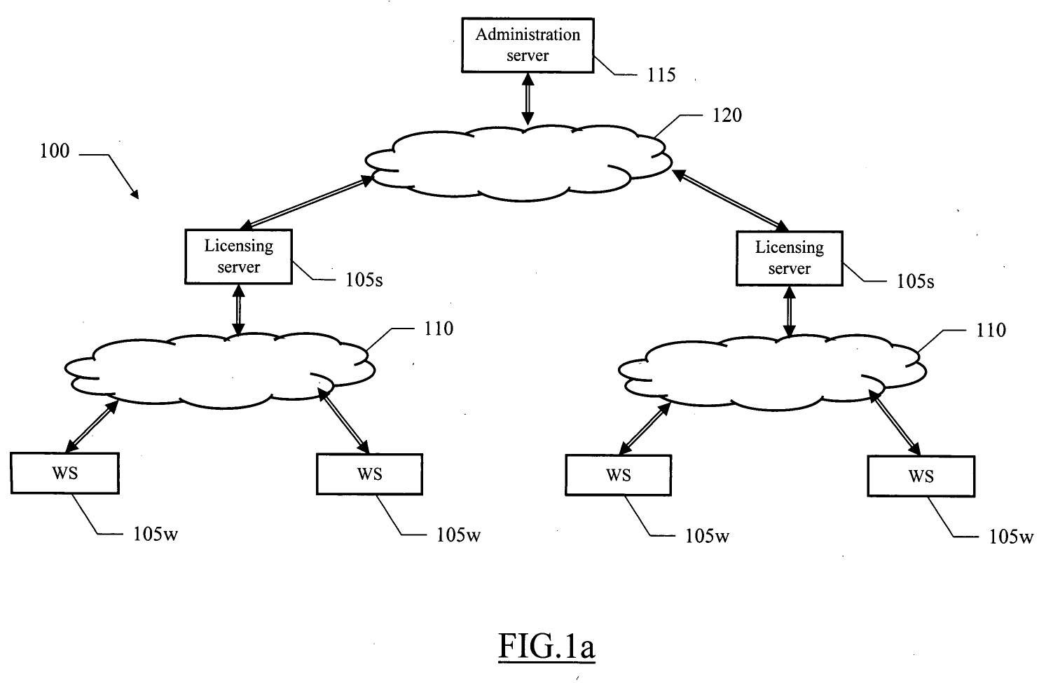

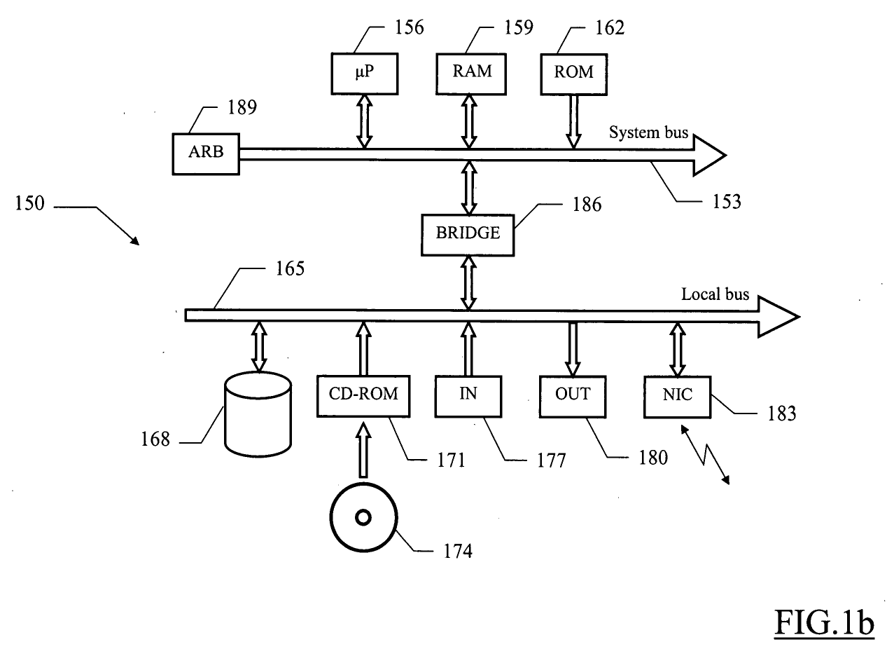

With reference in particular to FIG. 1a, a data processing system 100 with distributed architecture is depicted. The system 100 includes multiple workstations 105w, which are grouped into different sets; a licensing server 105s is associated with the workstations 105w of each set. The licensing server 105s and the corresponding workstations 105w are connected to each other through a network 110 (for example, a LAN). The different licensing servers 105s communicate with a remote administration server 115 through a different network 120 (for example, INTERNET-based); the administration server 115 implements a central repository where usage, procurement and inventory data of the system 100 is collected and managed.

As shown in FIG. 1b, a generic computer of the system (workstation, licensing server, or administration server) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Peripheral units are clustered around a local bus 165 (by means of respective interfaces). Particularly, a mass memory consists of a hard-disk 168 and a drive 171 for reading CD-ROMs 174. Moreover, the computer 150 includes input devices 177 (for example, a keyboard and a mouse), and output devices 180 (for example, a monitor and a printer). A Network Interface Card (NIC) 183 is used to connect the computer 150 to the network. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

Similar considerations apply if the system has a different topology, or it is based on other networks. Alternatively, the computers have a different structure, include equivalent units, or consist of other data processing entities (such as PDAs, mobile phones, and the like). In any case, the solution of the invention is also suitable to be used in a system wherein the control of the workstations is decentralized, or even in a stand-alone computer.

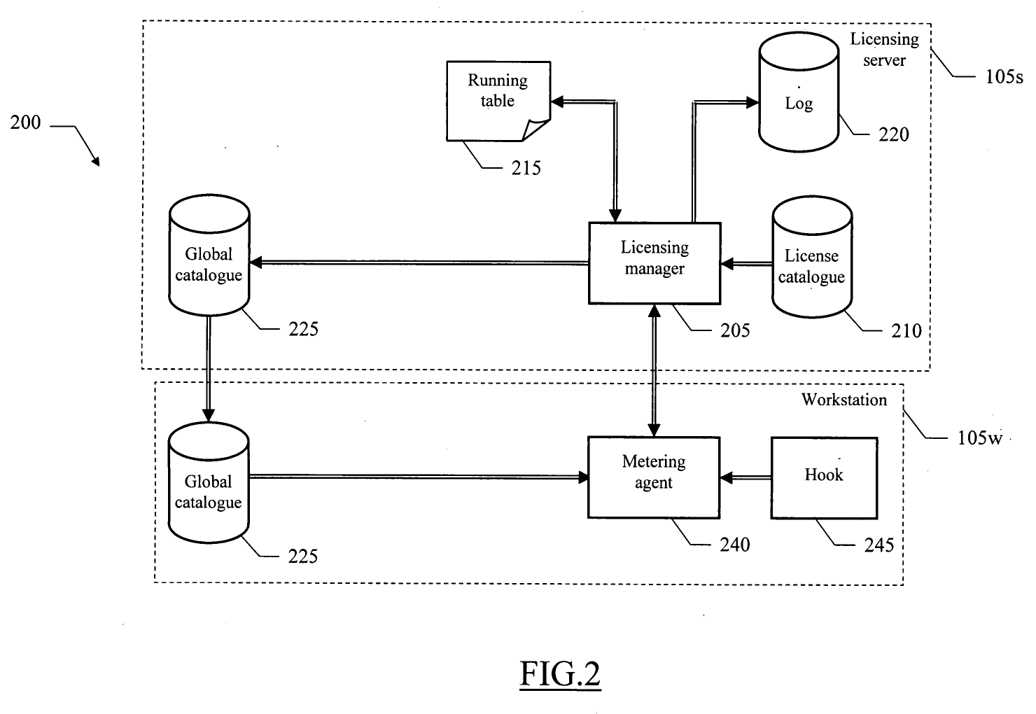

Considering now FIG. 2, the main software components that can be used to practice the method of a preferred embodiment of the invention are denoted as a whole with 200. The information (programs and data) is typically stored on the hard-disks of the different computers and loaded (at least partially) into the corresponding working memories when the programs are running.

Considering in particular a generic licensing server 105s, a corresponding manager 205 controls the associated workstations 105w (only one shown in the figure). The licensing manager 205 accesses a license catalogue 210, which contains information about the authorised conditions of use of different software products; for example, the authorisation catalogue 210 specifies the maximum processing power or the maximum capacity of the working memories of the workstations 105w on which each product can run, the number of licenses for the product (defining the maximum number of instances of the product allowed to run concurrently), and the like. Typically, more than one license is available for each product. The licensing manager 205 also controls entering of information into a running table 215, which lists the products currently in execution on the workstations 105w. In addition, the licensing manager 205 collects information from the corresponding workstations 105w (for example, about the installed programs, any attempts to run non-authorised or unknown products, and the like); this information is stored into a corresponding log 220.

The licensing server 105s also stores a global software catalogue 225, which is distributed to each workstation 105w. The global catalogue 225 lists all the known products to be metered in the system.

The global catalogue 225 is accessed by a metering agent 240 running in the background. The metering agent 240 also interfaces with a hook module 245. The hook 245 is implemented by means of a kernel extension, which adds functionality to an operating system of the workstation 105w using publicly available, standard interfaces. The hook 245 intercepts the starting of any new process on the workstation 105w, and reports the name of the corresponding executable module that has been invoked to the metering agent 240. The metering agent 240 determines the product (corresponding to the invoked executable module) that has been launched. The name of the product being launched is then transmitted to the licensing manager 205. The licensing manager 205 grants or denies the authorization to run the product (using the license catalogue 210 and the running table 215). The result of the process is stored into the log 220 and it is returned to the metering agent 240 (updating the running table 215 if necessary); the metering agent 240 then resumes or aborts the corresponding process accordingly.

Similar considerations apply if the programs and data are structured in a different manner, if other modules or functions are provided, or if the information is stored in equivalent memory structures. In any case, the solution of the invention is also suitable to be implemented with a licensing manager that controls the authorisations to run the products directly on each workstation.

When a request for a license is received (e.g. upon detection of a product being launched on the system) the license manager 205 determines if a suitable license is available. Particularly, if a single version of a license is available on the license catalogue 210, no choice is needed and the license can be granted without any other actions. Conversely, if more than one license for the same product is available then a decision mechanism is required.

E.g., let's assume that a license request for product P1 is received and the following licenses are available in the Catalogue for P1:

| License | Target | Quantity | Version level | Expiration date |
|---|---|---|---|---|
| L1 | Enterprise | 10 | Any level | 10/22/2004 |
| L2 | Division | 2 | 3 | 11/22/2004 |
| L3 | Division | 5 | 3.2 | 10/22/2004 |

As the above example shows, licenses may be assigned to specific targets, meaning that they can be granted only to requestors that belong to assigned targets. For instance, a license with “division” as a target type can be granted only to requests coming from machines that belong to the assigned divisions. Divisions may define logical groupings of machines, representing for instance the different departments of the same organization. It should be evident that “division” is a narrower target than “enterprise”.

To optimize license use, the licensing manager according to a preferred embodiment of the present invention is configured to privilege licenses with a “finer” (or narrower) target first, if the target is compatible with the requested product requirements.

In case two licenses has the same target (e.g. in the example above L2 and L3) the second attribute is considered.

In such case it is better to choose license L2, because there is a lower maximum quantity (i.e. the maximum number of instances of the product allowed to run concurrently) of licenses available while keeping L3 for future needs. In our example, if choosing to use the target type first and then the quantity for license selection, the license server will grant licenses with the following order: L2, L3, L1.

A wider list of attributes may include e.g. also the version level. In the example above L1 has the broadest scope as it is suitable for any version of the product P1, while license L3 has the narrowest scope.

Similarly, the license expiration date is another good attribute to be considered when optimizing license use, since it's better to use licenses that expire sooner, rather than saving them and preferring licenses that expire later.

A relative or absolute weight could be defined on each license. License administrators could define relative weights for all licenses that have been purchased by their organization, and a license server could use them to understand which licenses should be used first. Absolute weights could be conversely defined by software vendors at the time they sell software licenses to organizations, to influence the order that is to be considered when deciding which license should be granted whenever multiple choices are possible.

According to a preferred embodiment of the present invention, the server does not need to evaluate the best license for each request. Instead of looking for all suitable licenses and choosing the best one, the server could maintain a list of all licenses in the order identified by these criteria, so that licenses that should be used first appear in earlier positions of the list. Then, the server should iterate the list from the first position, and look for a license that is suitable for the current request. By doing so, the server will efficiently extract both a suitable license and the best suitable license, according to the optimization criteria that have been defined. Referring to the example above, if the requirements include a quantity of 3 licenses, then L2 will not be suitable, even it is the first in the list and the following license in the list (L3) will be considered.

Generalizing the concepts, license optimization criteria are applied on the basis of license attributes and specifically on the values of these attributes. For each of the attributes that define a license (A1, . . . Ai), a range of allowed values exist (Ai1, . . . Aik for attribute Ai). In comparing two licenses, the optimization criteria define which attributes must be considered first, and how attribute values are ordered within the range allowed for each attribute, so that the best license is always defined.

As an example, if choosing “target type” as attribute A1 and “expiration date” as attribute A2, when comparing two licenses the target type must be considered first. If the two licenses have different values for the target type, for instance A11=‘division’ and A12=‘enterprise’, the one having A11 is to be preferred to the one having A12.

If the two licenses compared have the same value for the target type, the second attribute A2, which in our example can be “expiration date”, is to be considered. If the two licenses have different values for the expiration date, for instance A21=“Oct. 22, 2004” and A22=“Nov. 22, 2004”, the one with A21 is to be preferred. If more than two attributes exist, the algorithm considers in turn all attributes, from A1 to Ai.

Additional features of the algorithm described include the possibility to consider the client identity. For instance, the license to be granted to a requesting client can be selected based on a defined priority function, which given two arguments, a license and a requesting client, may define the priority of the client with respect to that license.

If this is done, the server should re-sort for each request the list of licenses before looking for a suitable one, since the optimization criteria depend on the license requester, and consequently each request requires iterating over existing licenses in a different order, otherwise it is not guaranteed that the best one is granted, according to the defined optimization criteria.

The method of ordering the preferred licenses according to a list of attributes, starting from the first one and considering the following only if a decision is not possible, is just one of several possibilities. One alternative could be to combine all the attributes, maybe with a relative weight and calculating a global “preference value” for each license.

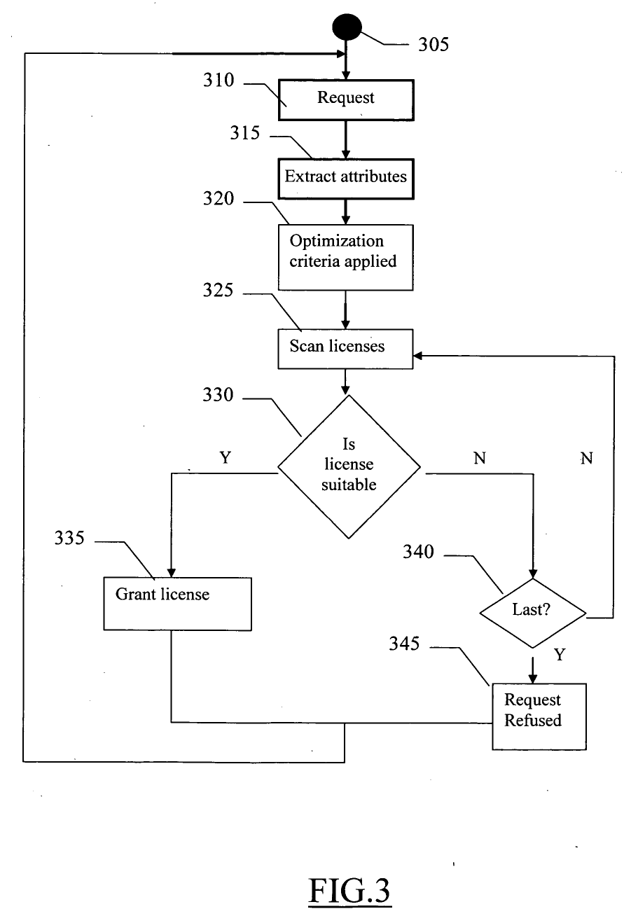

Considering now FIG. 3, the logic flow of a metering process according to an embodiment of the invention is represented with a method 300. The method begins at the black start circle 305. Continuing to block 310, a request is received by the licensing manager 205. The request is normally triggered by the detection of the start of a new process as explained above.

The method passes to block 315, wherein the attributes are extracted from the license catalogue 210. At block 320 all available licenses are ordered to maximize their exploitation according to predetermined optimization criteria as described above. At block 325 the list of available licenses is scanned according to the optimized order. Block 330 checks for each license if the license is suitable for the request until a suitable license is found. If not the control goes to block 340, which checks if there are more licenses in the list or not, passing respectively the control to block 325 or to the beginning, without being able to grant a license (message at block 345) waiting for another request. Conversely, when a suitable license is found, the Licensing Manager grants the use of the license and the process returns to the beginning, waiting for the next request. In this way the first suitable license in the ordered list is the best license (according to the criteria applied) and it is the license which is granted.

Similar considerations apply if the method includes equivalent or additional steps.

Alternatively, the list of attributes can be customized according to user selection or can be based on other conditions. In the same way the optimization criteria can be defined by different expressions, even using more complex logical operators. Also the determination if a license is suitable for the requested use or not could be done before the evaluation and sorting of the attributes.

Although not described in detail in order to avoid obscuring the description of the invention with unnecessary details, it is obvious that a procedure is also provided for notifying the licensing manager when the execution of a product is terminated (so as to update the table of available licenses). In addition, it is possible to have each workstation send a heartbeat message to the licensing manager periodically (for example, every ten minutes); in this way, the products running on the workstation can be deleted from the running table (in order to release the respective licenses) if the heartbeat message is not received within a predefined period (meaning that the workstation is not working correctly). Moreover, the administration server periodically collects the information logged on the different licensing servers, in order to create different reports (for example, relating to the installation and/or usage of the products on the workstations).

Although the invention has been described above with a certain degree of particularity with reference to preferred embodiment(s) thereof, it should be understood that various changes in the form and details as well as other embodiments are possible. Particularly, it is expressly intended that all combinations of those elements and/or method steps that substantially perform the same function in the same way to achieve the same results are within the scope of the invention.

For example, the use of the proposed solution in a context different than the licensing management is contemplated. Particularly, the information that has been detected about the products can be used for reporting or inventory purposes only (without any verification of their authorizations). Alternatively, the products are always allowed to run (for example, only logging an exception when their use is not authorized). Also it is to be noted that the term “use” when referred to a software product may include the simple installation or loading of the product in the system memory.

In any case, the method of the invention can be used to meter any kind of software products (such as a video games, multimedia works, and the like); moreover, the launch of the products can be detected in another way (for example, periodically collecting a list of the executable modules that are running).

In addition, the programs can be distributed on any other computer readable medium (such as one or more DVDs); alternatively, the programs are pre-loaded onto the hard-disks, are transmitted to the computers, are broadcast, or more generally are provided in any other form directly loadable into the working memories of the computers.

Moreover, it will be apparent to those skilled in the art that the additional features providing further advantages are not essential for carrying out the invention, and may be omitted or replaced with different features.

In any case, the method according to the present invention is also suitable to be carried out with a hardware structure (for example, integrated in a chip of semiconductor material), or with a combination of software and hardware.

Naturally, in order to satisfy local and specific requirements, a person skilled in the art may apply to the solution described above many modifications and alterations all of which, however, are included within the scope of protection of the invention as defined by the following claims.

1. A method of metering usage of at least one software product on a data processing system, the at least one software product having a plurality of available associated licenses, each license having a set of attributes, the method including the steps of:
determining for each attribute a preference rule;
detecting an event indicative of the use of the at least one product on the system, and
responsive to the detection, identifying the best available license for the product among said plurality of licenses, according to said preference rules.

2. The method according to claim 1, wherein the attributes are indicative of usage constraints of the product.

3. The method of claim 1 wherein the step of determining includes determining for at least one attribute a preference rule identifying which of the plurality of licenses has the highest usage constraint.

4. The method according to claim 3 wherein the at least one attribute includes the category of the product user.

5. The method according to claim 3 wherein the set of attributes includes the license expiration date.

6. The method according to claim 1, wherein the at least one product has a set of usage requirements and the step of identifying includes the steps of:
creating for each product an ordered list of the available licenses according to the preference rules;
scanning the list until a suitable license having all the attributes matching the product usage requirements, is found.

7. The method according to claim 6, wherein the ordered list includes only suitable licenses.

8. (canceled)

9. (canceled)

10. An apparatus for metering usage of software products on a data processing system, each software product having a plurality of available associated licenses, the apparatus including:
means for determining for each attribute a preference rule;
means for detecting an event indicative of the use of a product on the system, and
means responsive to the detection, for identifying the best available license for the product among said plurality of licenses, according to said preference rules.

11. A computer product in a computer readable medium for metering usage of software products on a data processing system, each software product having a plurality of available associated licenses, the product comprising:
instructions for determining for each attribute a preference rule;
instructions for detecting an event indicative of the use of a product on the system, and
instructions responsive to the detection, for identifying the best available license for the product among said plurality of licenses, according to said preference rules.
